(19) United States
(12) Patent Application Publication
(10) Pub. No.: US 2013/0323704 A1
(43) Pub. Date: Dec. 5, 2013

(54) SYSTEMS AND METHODS FOR ASSESSMENT OF FLUID INTELLIGENCE

(71) Applicant: LUMOS LABS, INC., San Francisco, CA (US)

(72) Inventors: Tyler HINMAN, San Francisco, CA (US); Ben KATZ, Averill Park, NY (US); Joseph L. HARDY, Richmond, CA (US)

(73) Assignee: LUMOS LABS, INC., San Francisco, CA (US)

(21) Appl. No.: 13/777,965

(22) Filed: Feb. 26, 2013

Related U.S. Application Data
(60) Provisional application No. 61/653,060, filed on May 30, 2012.

(51) Int. Cl. G09B 5/00

(52) U.S. Cl. CPC G09B 5/00
USPC 434/322

(57) ABSTRACT

A computing device determines a matrix reasoning assessment (MRA) to assess fluid intelligence of a user operating a client computer/device. The MRA includes a matrix having designs in design spaces, where the designs form one or more patterns. The matrix has one or more design spaces in the matrix that are missing a design. Examples of a design include, without limitation, a number, a letter, a symbol. a shape, a picture, an image, a photograph, an icon, an animation, a video, audio, or any other symbol, character, or representation that can be used in a pattern. In one embodiment, the computing device transmits the matrix to the client device. The user responds with a design for the “empty” design space (i.e., the design space previously missing a design) and the computing device receives this design selection.

### CROSS REFERENCE TO RELATED APPLICATIONS

This patent application claims the benefit of Provisional Patent Application Ser. No. 61/653,060, titled “Systems and Methods for Assessment of Fluid Intelligence” filed on May 30, 2012, the contents of which are incorporated herein by reference.

### BACKGROUND OF THE INVENTION

The gold standard assessment of fluid intelligence, i.e., the ability to creatively solve new problems, is matrix reasoning. Performance on standardized, paper-and-pencil matrix reasoning assessments, like Raven's Progressive Matrices and the Test of Nonverbal Intelligence (TONI), have been shown to correlate with many important real-life outcomes like educational attainment and professional success. In a matrix reasoning assessment, a test-taker must select the most logical element to complete a progressive pattern of elements arranged in a figural matrix from an array of potential answer choices.

Existing matrix reasoning assessments suffer from a number of limitations, however. In particular, all current comprehensive, widely available matrix-reasoning assessments are paper-and-pencil tests. Administering such tests presents a number of logistical problems, including the need for a clinician to supervise and score the test. In addition, these assessments typically come in at most two forms. Thus, if one wishes to assess fluid intelligence at multiple time points, some test items must be reused, leading to large test-retest practice effects.

### SUMMARY OF THE INVENTION

Systems and methods for assessment of fluid intelligence are disclosed. The systems and methods provide a mechanism for ensuring that users are able to assess fluid intelligence using remote computing technology in a form that is highly repeatable. This assessment uses algorithmic approaches for item generation that allow real time creation of new test items. These items are classified by the type and number of logical reasoning operations required for solving them, allowing the difficulty of a generated item to be determined a priori. This characteristic allows for accurate comparison across retests as well as adapting difficulty across trials, based on a user's responses. The computer-based nature of the assessment means that it can be implemented on the Internet in a browser, or on a smartphone (e.g., iPhone®), on a tablet-computing device (e.g., iPad®). In fact, any computing system that can compute the matrices, display the visual content, take user input, and store data could be used. In one embodiment, an implementation occurs in an interactive multimedia environment such as Flash or HTML5 for display in a web browser, as well as smartphone- and tablet-specific implementations (such as iOS and Android™ operating systems).

In one aspect, a computing device determines a matrix reasoning assessment (MRA) to assess fluid intelligence of a user operating a client computer/device. The MRA includes a matrix having designs in design spaces, where the designs form one or more patterns. The matrix has one or more design spaces in the matrix that are missing a design. Examples of a design include, without limitation, a number, a letter, a symbol. a shape, a picture, an image, a photograph, an icon, an animation, a video, audio, or any other symbol, character, or representation that can be used in a pattern. In one embodiment, the computing device transmits the matrix to the client device. The user responds with a design for the “empty” design space (i.e., the design space previously missing a design) and the computing device receives this design selection.

The computing device determines whether the received design is correct for the design space. The computing device then transmits to the user an indication as to whether the received design is correct for the design space. This indication may be shading of the correct design or displaying the correct design in a specific or different color.

In one embodiment, a user selects the design from an options section displayed near (e.g., below) the displayed matrix. The computing device may determine the size of the matrix and/or the shape of the matrix before transmitting the matrix to the client device for display. As described above, the matrix in the MRA may be determined from one or more of a variety of rules, such as progression matrix rules, orbital or lateral movement rules, and/or boolean logic rules. The computing device can adjust the difficulty of the matrix/pattern, and this adjustment may be based on if the user selected a correct design for the missing design space, the number of correct designs selected by the user for different matrices, the difficulty level of the current matrix, etc.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example, Levitt, H (1971). “Transformed Up-Down Methods in Psychoacoustics.” J. Acoustical Soc. of Am., 49(2), 467-77 and Matzen, L., et al. (2010). Recreating Raven's: Software for systematically generating large numbers of Raven-like matrix problems with normed properties. Behavior Research Methods, 42(2), 525-541.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A is a block diagram showing a representative example of a logic device through which assessment of fluid intelligence can be achieved;

FIG. 1B is a block diagram of an exemplary computing environment through which assessment of fluid intelligence can be achieved;

FIG. 1C is an illustrative architectural diagram showing some structure that can be employed by devices through which assessment of fluid intelligence can be achieved;

FIG. 2 is a block diagram showing the cooperation of exemplary components of a system suitable for use in a system in which assessment of fluid intelligence can be achieved;

FIG. 3 depicts an example matrix from the assessment wherein the user selects the figure from the bottom answer array that best completes the object progression in the stimulus matrix. In this case, the correct answer is the 3^{rd} figure from the left in the answer set. This is an example of a progression matrix, with color changing horizontally;

FIG. 4 depicts an example of a progression matrix with both numbers and size changing vertically;

FIG. 5 depicts an example of a progression matrix with color changing diagonally from the upper left to the lower right;

FIG. 6 depicts an example of a progression matrix with the number changing diagonally from lower left to upper right and the color changing horizontally;

FIG. 7 depicts an example of a progression matrix with the shape changing outwardly, the orientation changing diagonally from lower left to upper right and the color changing horizontally;

FIG. 8 depicts an example with orbital-lateral movement progression where the movement occurs down the columns, and the squares rotate around the middle in a counterclockwise direction;

FIG. 9 depicts another example with orbital-lateral movement where the movement occurs down the columns, and the circles rotate around the middle in a clockwise direction;

FIG. 10 depicts Boolean logic where transformation occurs across the rows using the AND rule such that a square is darkened in the right column if and only if that location is darkened in both of the two graphics to its left;

FIG. 11 depicts another example of Boolean logic where transformation occurs across the rows using the OR rule such that a segment appears in the rightmost column if and only if it appears in at least one of the two illustrations to its left;

FIG. 12 depicts an example of steps performed by a computing device to determine fluid intelligence;

FIGS. 13A-13B depict examples with movement progression for a correct answer;

FIGS. 13C-13D depict examples with movement progression for an incorrect answer; and

FIG. 14 depicts an example of a practice session.

### DETAILED DESCRIPTION OF THE INVENTION

### I. Computing Systems

The systems and methods described herein rely on a variety of computer systems, networks and/or digital devices for operation. In order to fully appreciate how the system operates, an understanding of suitable computing systems is useful. The systems and methods disclosed herein are enabled as a result of application via a suitable computing system.

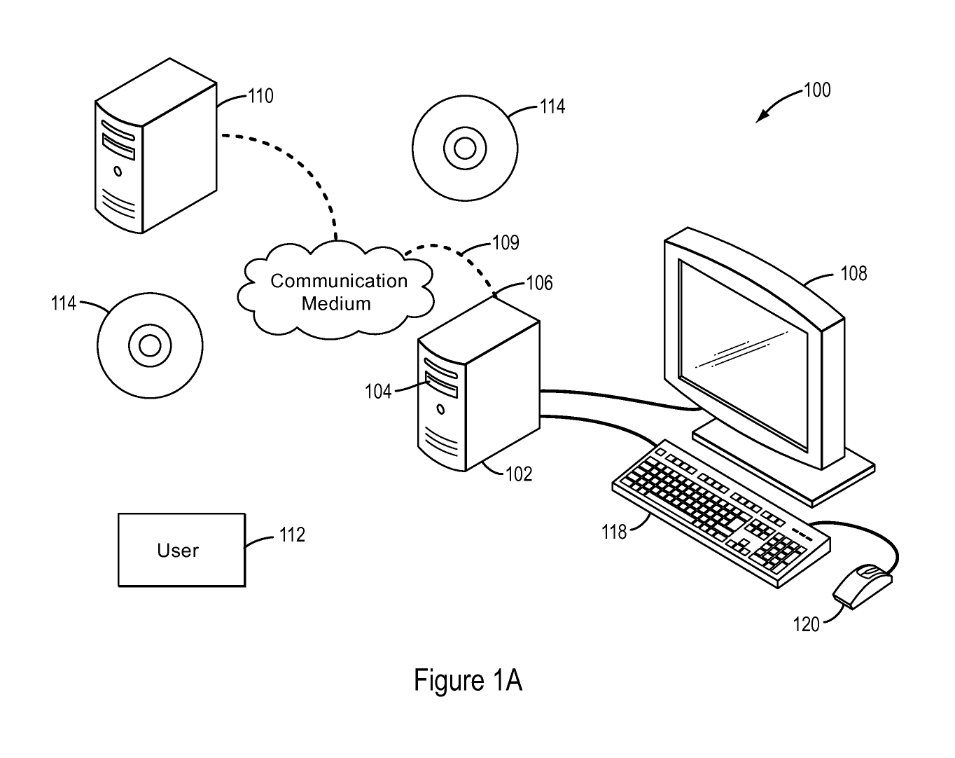

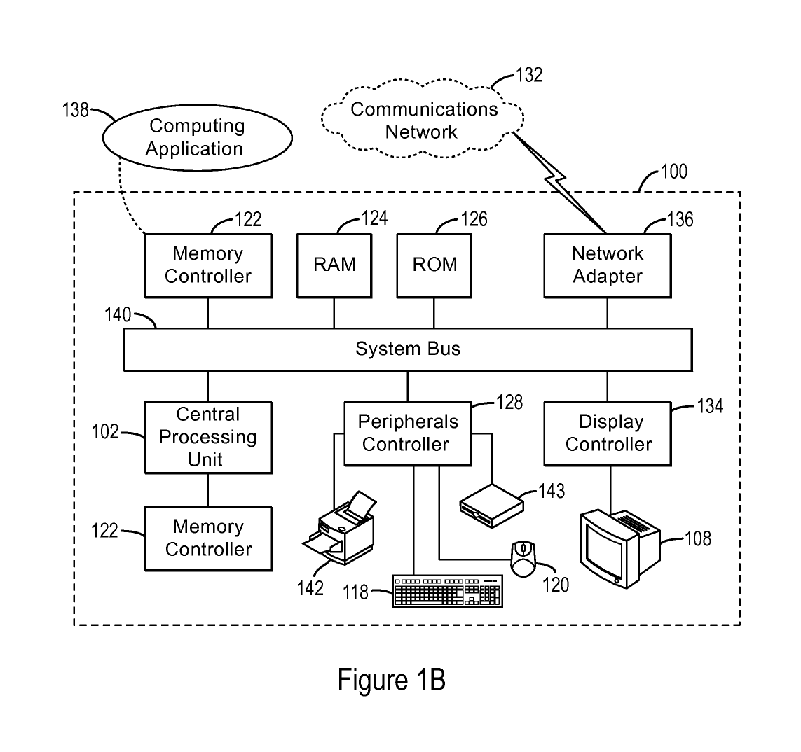

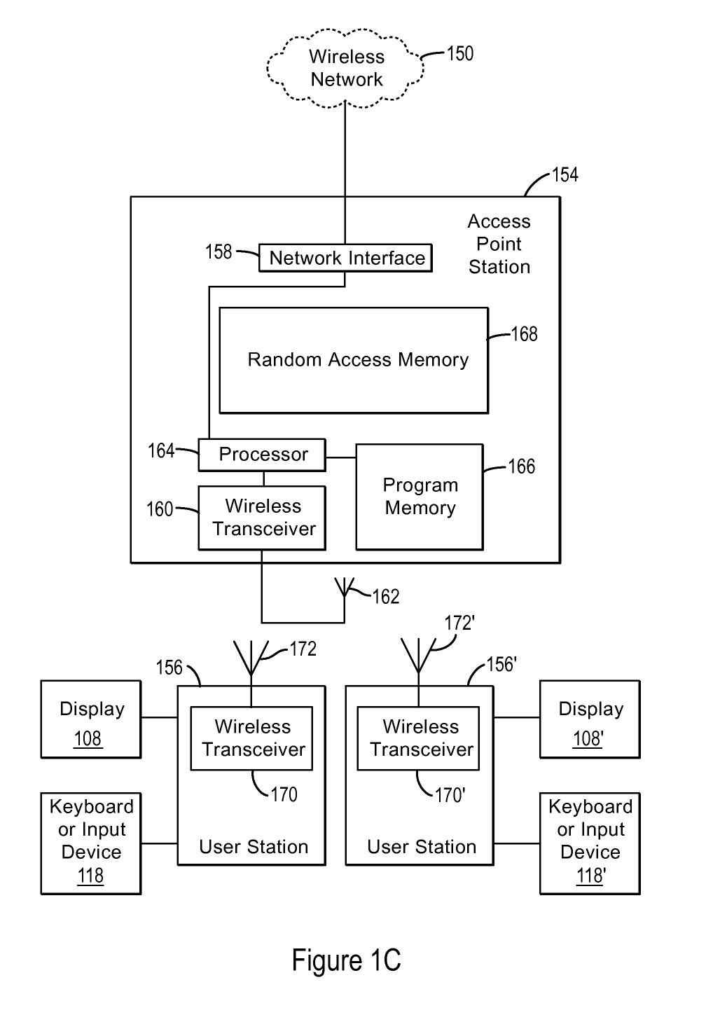

FIG. 1A is a block diagram showing a representative example logic device through which a browser can be accessed to implement the present invention. A computer system (or digital device) 100, which may be understood as a logic apparatus capable of reading instructions from media 114 and/or network port 106, is connectable to a server 110, and has a fixed media. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present disclosure can be transmitted over such networks or connections. The computer system can be capable of, or in at least some situations capable of, communicating with a participant and/or a device used by a participant. The computer system is capable of communicating with other computers over the Internet, or with computers via a server.

FIG. 1B depicts another exemplary computing system 100. The computing system 100 is capable of, or in at least some situations adaptable for, executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media capable of, or in at least some situations adaptable to, tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers, CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 134, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

FIG. 1C depicts components that can be employed in system configurations enabling the systems and technical effect of this disclosure, including wireless access points to which client devices communicate. In this regard, FIG. 1C shows a wireless network 150 connected to a wireless local area network (WLAN). The WLAN includes an access point (AP) 154 and a number of user stations 156, 156′. For example, the network 150 can include the Internet or a corporate data processing network. The access point 154 can be a wireless router, and the user stations 156, 156′ can be portable computers, personal desktop computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172′ for communication to the access point 154. By way of example, in some embodiments an authenticator could be employed within such an access point (AP) and/or a supplicant or peer could be employed within a mobile node or user station. Desktop 108 and keyboard 118 or input devices can also be provided with the user status.

### IV. Access Via Browser

In at least some configurations, a user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application capable of or adaptable to allowing access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

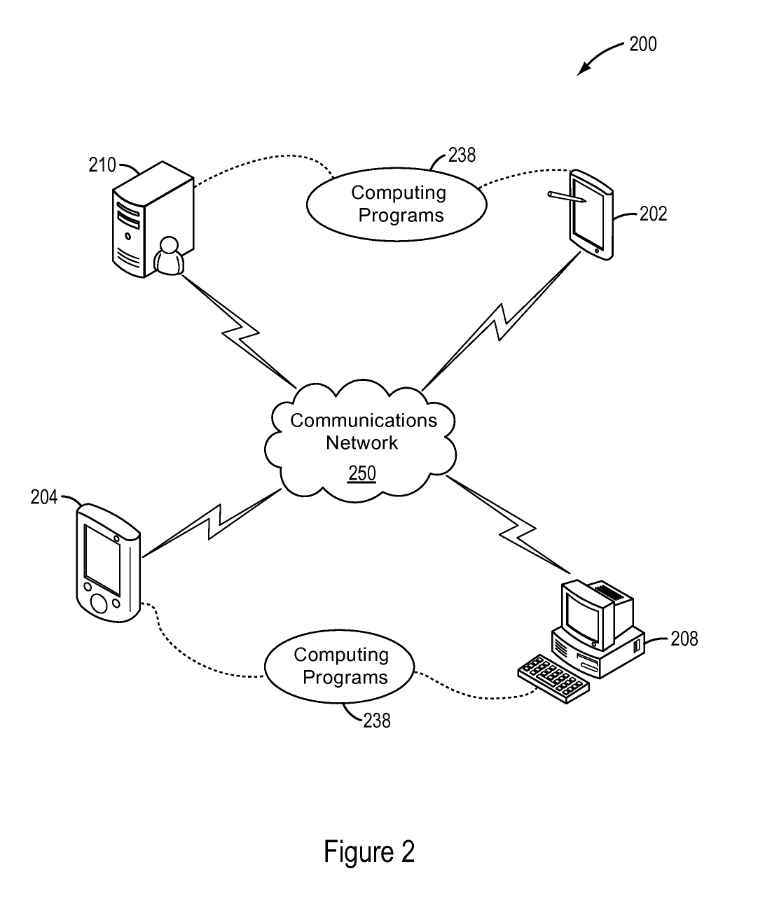

Computing system 100, described above, can be deployed as part of a computer network used to achieve the desired technical effect and transformation. In general, the above description for computing environments applies to both server computers and client computers deployed in a network environment. FIG. 2 illustrates an exemplary illustrative networked computing environment 200, with a server in communication with client computers via a communications network 250. As shown in FIG. 2, server 210 may be interconnected via a communications network 250 (which may be either of, or a combination of a fixed-wire or wireless LAN, WAN, intranet, extranet, peer-to-peer network, virtual private network, the Internet, or other communications network) with a number of client computing environments such as tablet personal computer 202, smart phone 204, personal computer 208, and personal digital assistant. In a network environment in which the communications network 250 is the Internet, for example, server 210 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 200 can utilize various data security protocols such as secured socket layer (SSL) or pretty good privacy (PGP). Each client computing environment can be equipped with operating system 238 operable to support one or more computing applications, such as a web browser (not shown), or other graphical user interface (not shown), or a mobile desktop environment (not shown) to gain access to server computing environment 200.

In operation, a user (not shown) may interact with a computing application running on a client computing environment to obtain desired data and/or computing applications. The data and/or computing applications may be stored on server computing environment 200 and communicated to cooperating users through client computing environments over exemplary communications network 250. The computing applications, described in more detail below, are used to achieve the desired technical effect and transformation set forth. A participating user may request access to specific data and applications housed in whole or in part on server computing environment 200. These data may be communicated between client computing environments and server computing environments for processing and storage. Server computing environment 200 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VII. Software Programs Implementable in the Computing and Network Environments to Achieve a Desired Technical Effect or Transformation

The matrix reasoning assessment (MRA) disclosed provides an approach to assessing fluid intelligence using, for example, remote computing technology in a form that is highly repeatable.

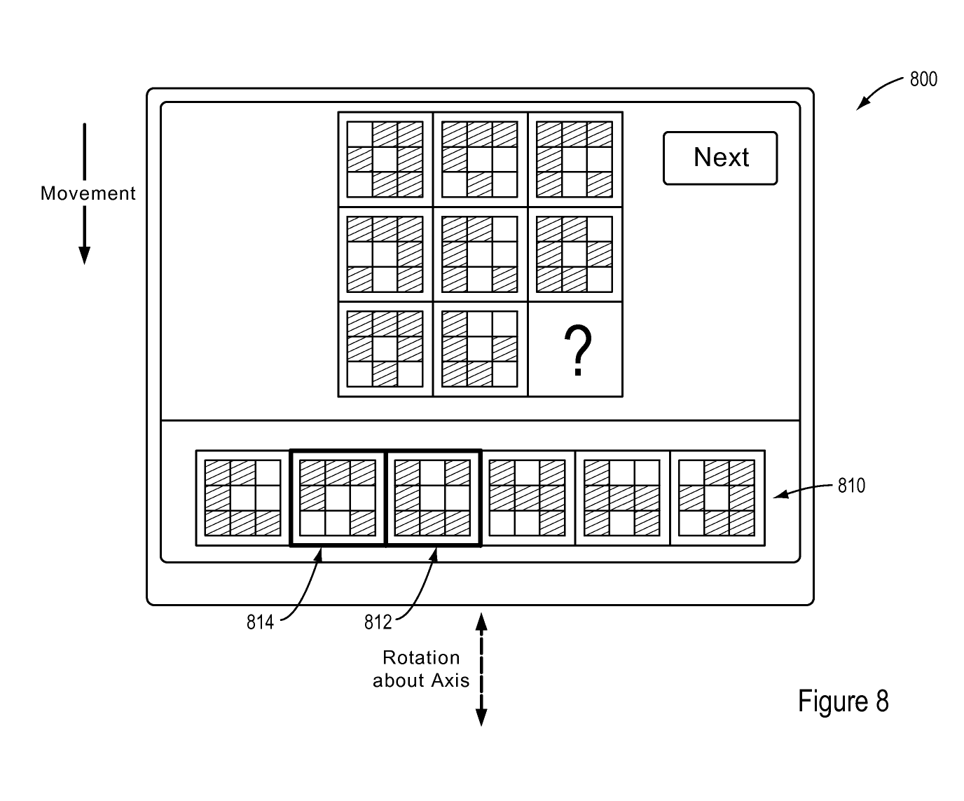

In this assessment, the user must decide which design fits in a specific area (e.g., the lower right corner) of a matrix (e.g., 3×3 matrix) to consistently complete the transformation suggested by the other shapes. The user chooses an option from a plurality of presented options that he or she feels most correctly completes the pattern in the rest of the matrix from a choice of several (e.g., 6) possible options placed graphically below the matrix. When the user selects the correct response, the box containing that response is, for example, shaded green (shown as a heavier outer box). When the user selects an incorrect response, the box containing the selected incorrect response is, for example shaded red, and the correct answer is shaded green. [See, FIG. 8 incorrect answer 814, and correct answer 812.] For persons who are color blind other mechanisms can be employed to distinguish between correct and incorrect answers.

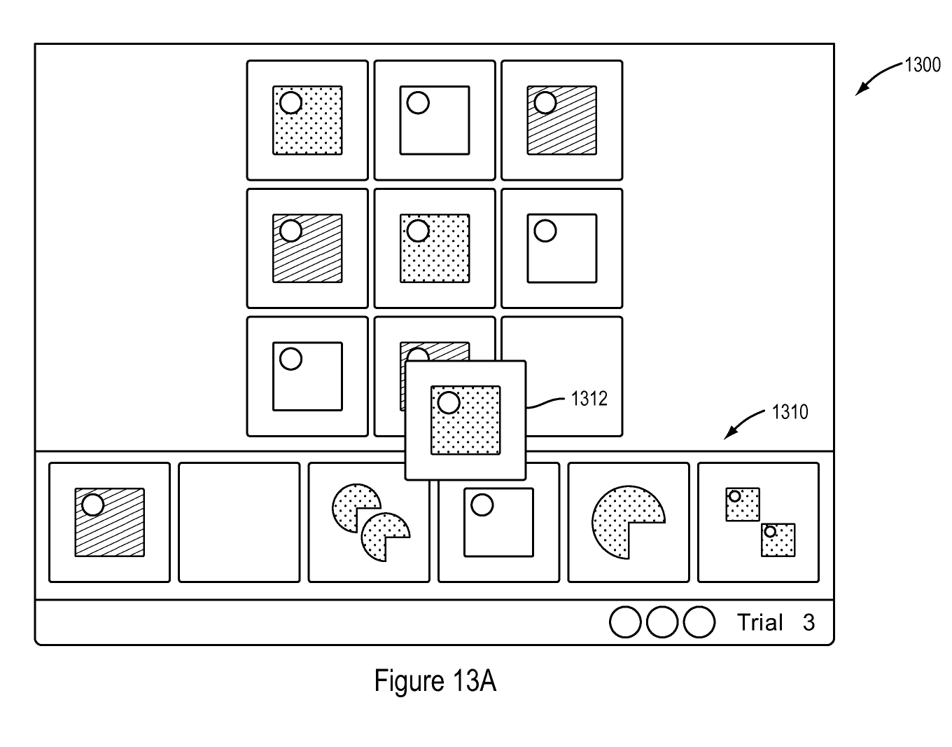

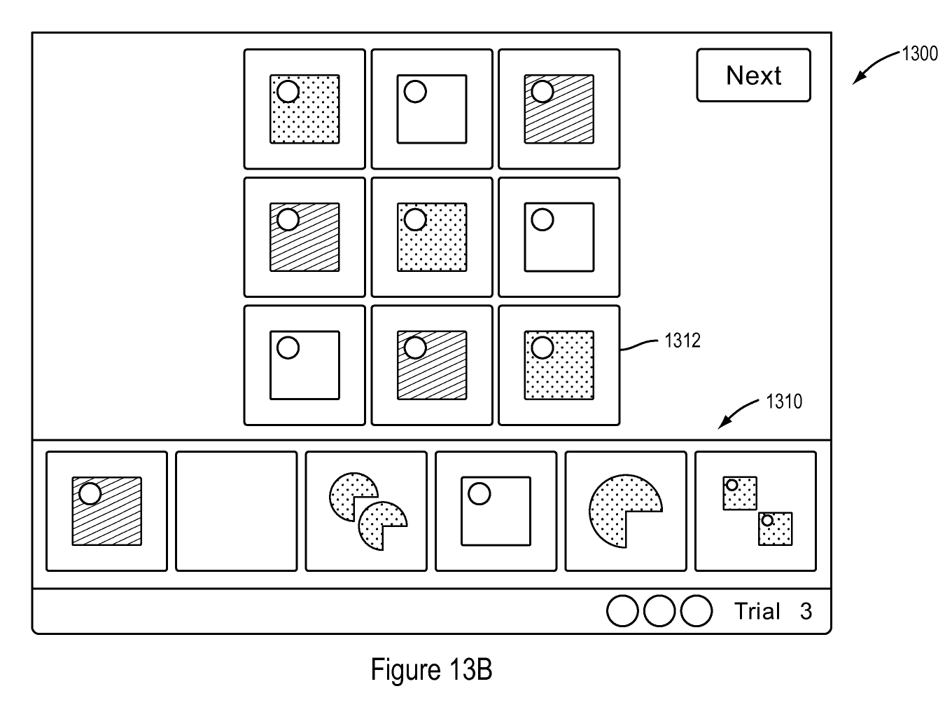

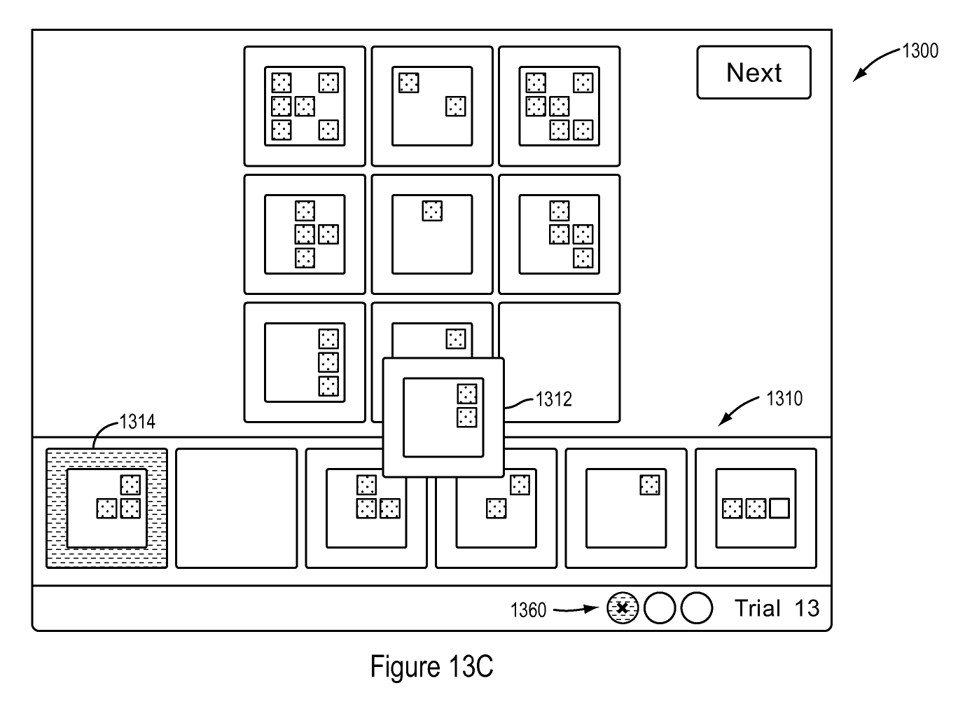

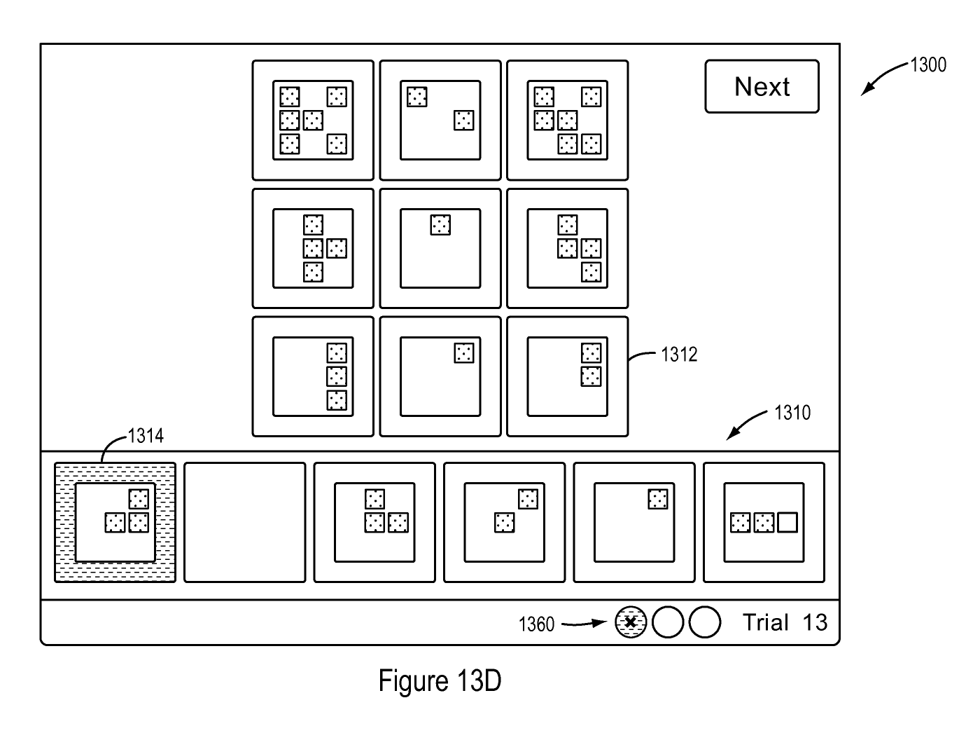

Referring to FIGS. 13A-13B, in one embodiment of a grid 1300 presented for completion with a series of potential answers provided in a bar 1310, a selected answer 1312 can also be physically moved (e.g., by drag and drop) to fit into the empty portion of the matrix 1300, thus completing it. The correct answer box also physically moves to fit into the empty portion of the matrix, but may not be shaded green. However, some indication that the correct selection has been made can be provided.

Additionally, in one embodiment, an X is placed on a status bar 1360 provided on the screen (illustrated at the bottom right) to signify an incorrect response. As shown in FIG. 13c the user had attempted to select 1314 which was an incorrect solution, resulting in an X appearing in the status bar 1360, and the user is in the process of selecting 1312 to the open box on the grid. In one embodiment, if a user makes three consecutive incorrect selections, the assessment may end immediately. When the user makes a correct selection prior by the third attempt, all Xes are cleared. The reasoning for this behavior is to reduce potential frustration a user may have if they are not performing well. When this assessment is part of a battery of assessments, we want the user to complete the entire set and not quit because they are not doing well on an individual assessment. (See, e.g., FIGS. 13C-13D).

As will be appreciated by those skilled in the art, changes can be made to the size and shape of matrix chosen (non-matrix configurations, such as L's and T's could also be used), colors used, shapes used, highlighting of correct and incorrect answers, etc.

Prior to beginning the assessment, the user is given brief instructions. The 3×3 matrix is described and the user is told to examine the eight items that appear in the matrix as well as the six possible figures that appear below in the answer bank. The user is instructed to select the figure from the answer bank that most appropriately fits in the remaining matrix space in the lower right. As will be appreciated by one skilled in the art, changes can be made to the configuration of the matrix, such that, for example, answer blanks could occur in other locations, such as the upper right, upper left and lower left. The user is also given information regarding feedback and the length of the test. In one embodiment, the user's progress with respect to the number of problems is also displayed throughout the test. The user may then review the answer until he or she decides to proceed to the next trial. A “Next” button appears beside the matrix after the user selects an option, and this button is clicked in order to proceed to the next trial.

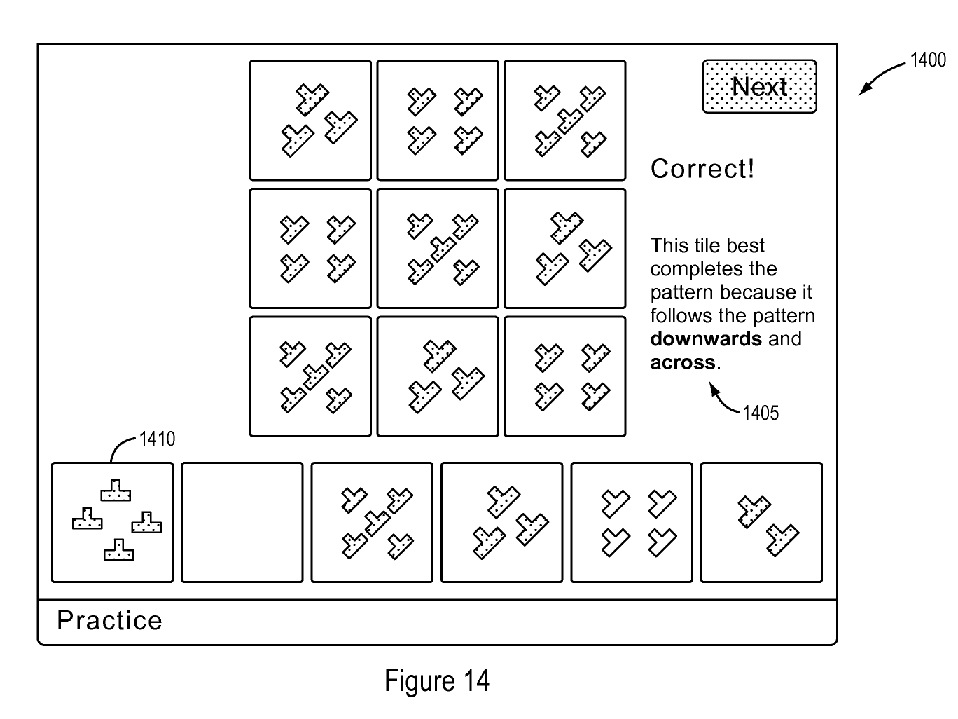

In one embodiment, a practice session of problems is also included from the first four Progression Matrix types (horizontal, vertical, diagonals). The user may be required to get a predetermined number of questions (e.g., four questions) correct in order to progress to the actual assessment signaling that they understand how the assessment works. As shown in FIG. 14, after each response, a brief description 1405 of why the correct answer is correct can appear once the grid 1400 has had an answer selected from the solution bar 1410.

The stimulus matrix is generated by combining sets of rules. There are three main types of rules that are used to determine matrix layouts:

### A. Progression Matrix.

These rule sets involve graphical transformations in one to three of five different possibilities along the same number of axes. The correct answer choice will continue all such transformations. The five characteristics that may change are shape, number, color, rotation angle, and size. The five axes are as follows:

1. Horizontal:

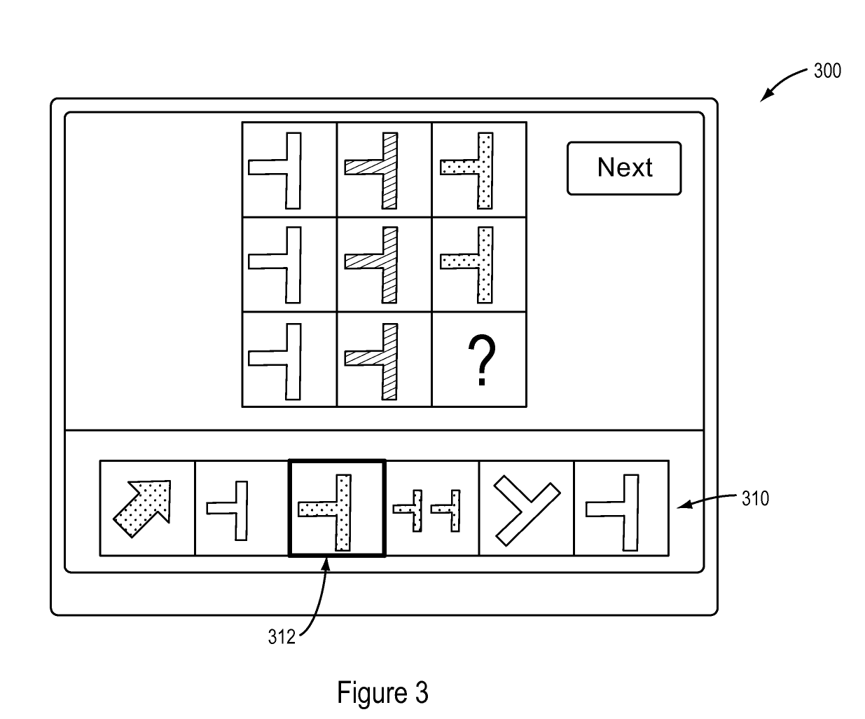

The change is applied from left to right. Thus, three distinct trios are shown in each trial of the matrix 300. The correct answer 312 is illustrated in a vertical bar 310 of choices below the matrix. (FIG. 3).

2. Vertical:

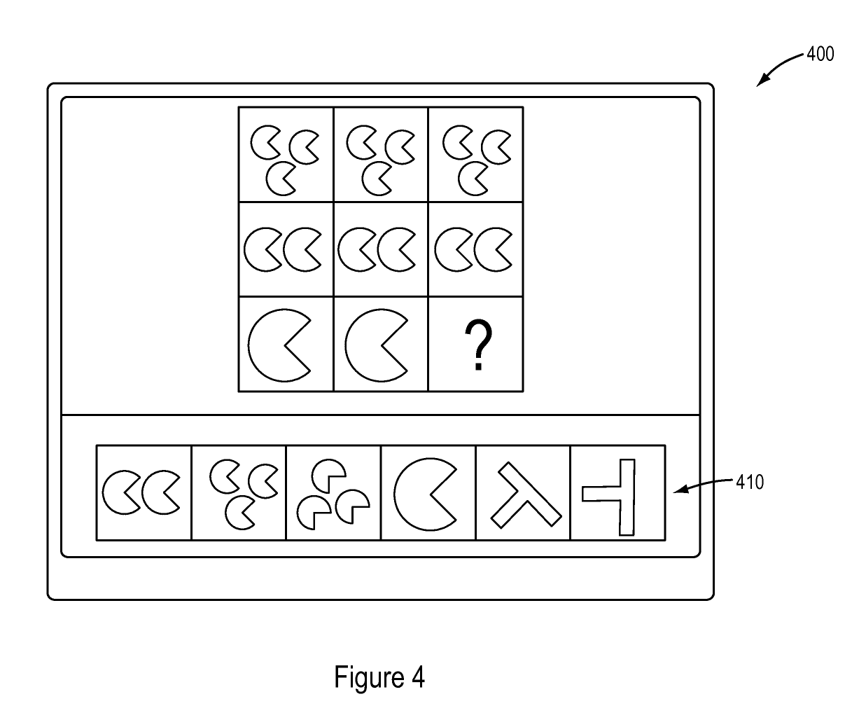

Like Horizontal, but the matrix 400 is applied from top to bottom (FIG. 4). A vertical bar of answer choices 410 is depicted below the matrix.

3. Upper-Left to Lower-Right Diagonal:

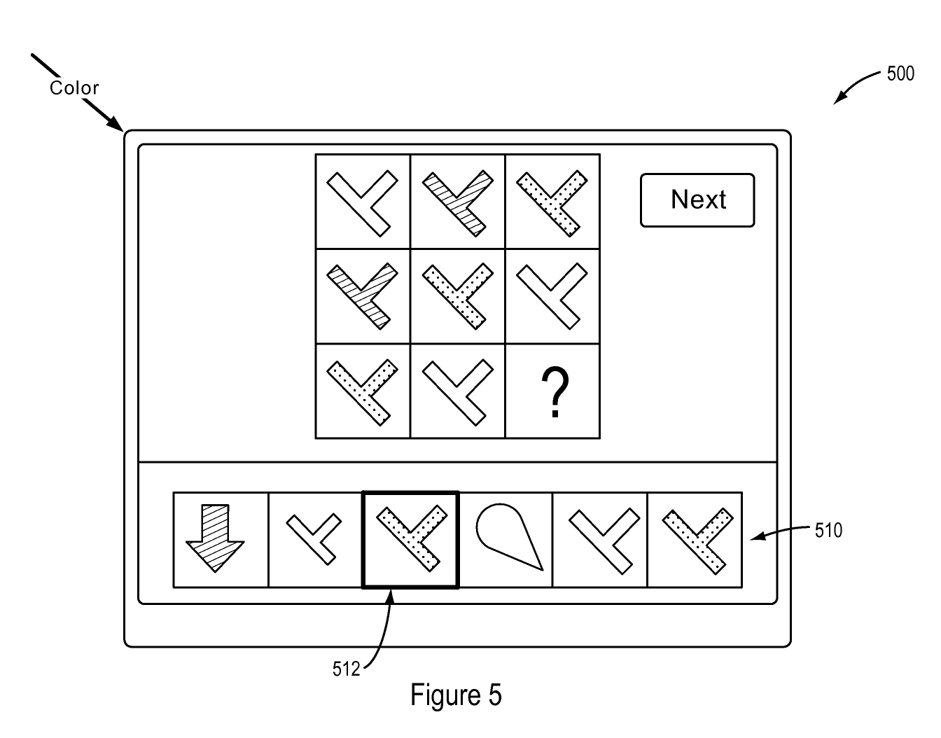

The upper left corner holds the first stage of the transformation. The second stage appears in the two squares immediately below and to the right. The third is shown in the squares immediately below and to the right of those, i.e. the main lower-left to upper-right diagonal. The matrix 500 pattern then starts over, proceeding in the same fashion (FIG. 5). Answer options are depicted in a horizontal bar 510 below the matrix, with the correct answer highlighted 512.

4. Lower-Left to Upper-Right Diagonal:

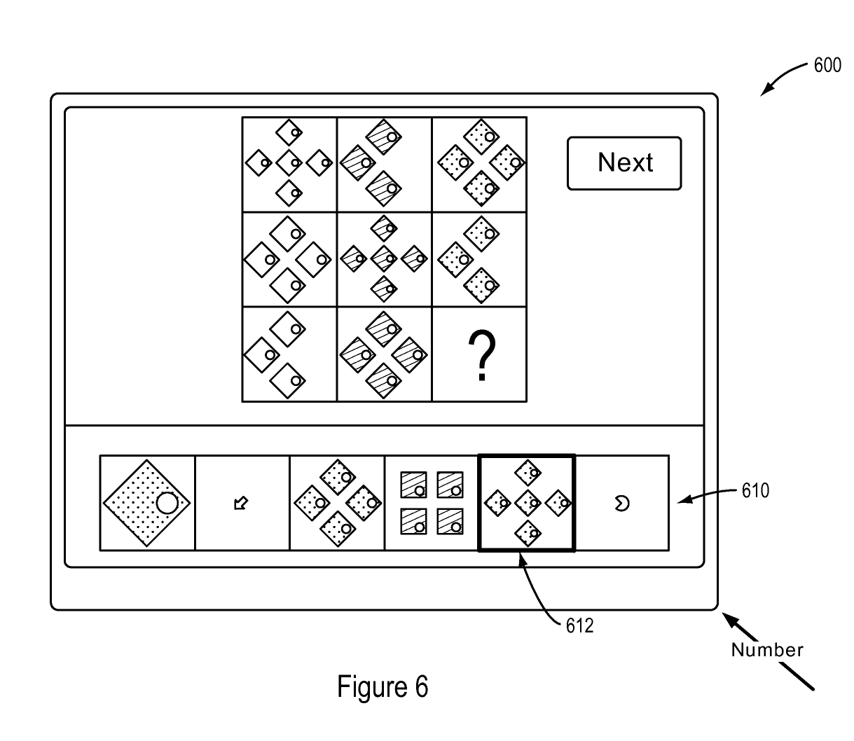

Like the matrix depicted in FIG. 5, but the matrix 600 starts from the lower left corner (FIG. 6). Answer options are depicted in a horizontal bar 610 below the matrix 600, with the correct answer highlighted 612.

5. Outward:

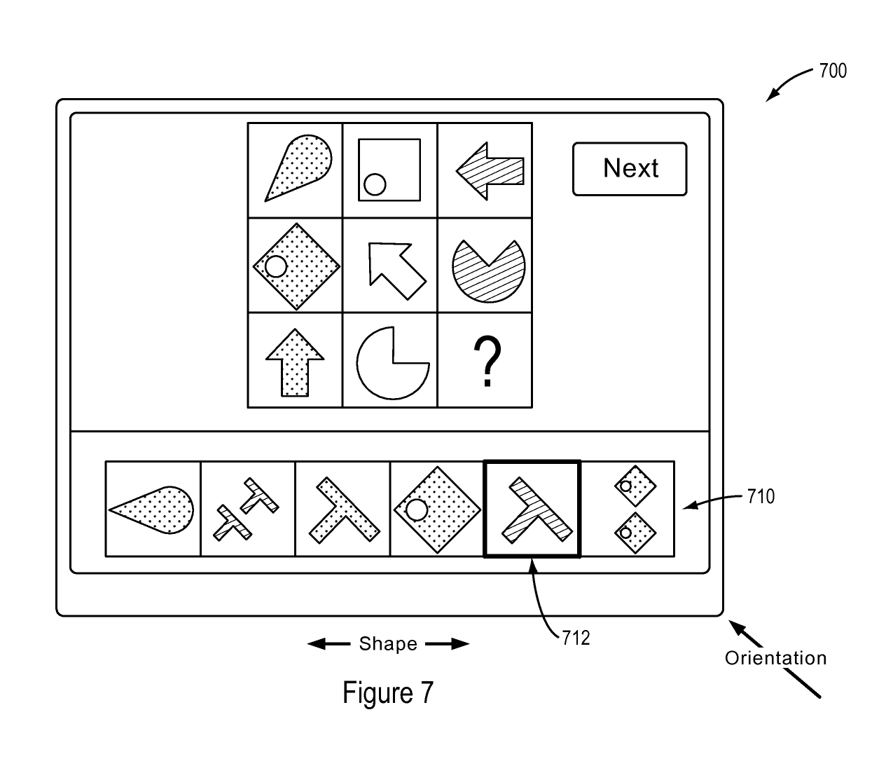

This transformation matrix 700 proceeds somewhat like the upper-left to lower-right example, but there are five stages rather than three that are cycled through. Thus, the fifth and final stage appears in the lower right corner (FIG. 7). Answer options are also illustrated as being positioned in a horizontal bar 710 below the matrix 700, with the correct answer highlighted 712.
A few measures are taken to ensure quality trials.
Shapes with rotational symmetry are not used.
Changes to the size and the number of copies are not permitted in the same trial. This is because increasing the number of items in a box requires those items to be smaller. Thus, it can be difficult to tell which factor is in play.
   In some configurations, the outward axis, shape and color changes could be avoided. In these cases, because the user must supply the symbol in the lower right corner, he/she must select a shape or color that does not appear elsewhere in the problem. This can be confusing. Rotation, size, and number are allowed because they have clear progressions from one step to the next (e.g. 45 degrees in the case of rotation).

### B. Orbital/Lateral Movement.

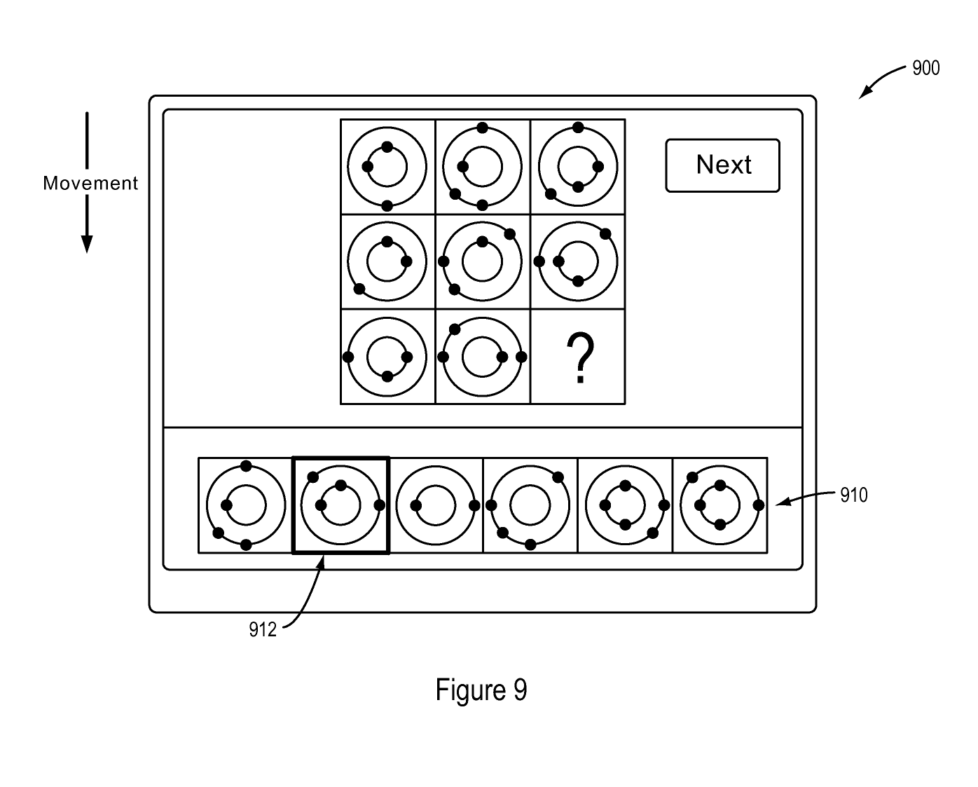

The graphic is either a small drawing of a 3×3 grid (not to be confused with the 3×3 grid that represents the whole trial), with some squares randomly filled in, or two concentric circles, with dots randomly placed at some of twelve possible points (four on the inner circle, eight on the outer). For effective and versatile trials, at least two squares/dots must be placed, and at least two possible spots must be empty. If lateral movement is chosen, the pattern of squares proceeds in one of the four cardinal directions. It does not wrap around; what “scrolls” off the edge is simply gone. For orbital movement, the squares/dots move one step either clockwise or counterclockwise. (In the grid's case, the middle square, filled or not, stays put.) The progression may occur along the horizontal or vertical axis; thus, there are three separate examples of the transformation per grid 800, as shown in FIG. 8. Correct answers are depicted in a horizontal row below the grid; with the correct answer highlighted green 812 and the incorrect (selected) answer 814 highlighted pink. In this case, the movement happens down the columns. The squares rotate around the middle in a counterclockwise direction. The problem in FIG. 9 depicts the round graphics in a grid 900; here, the movement is also down the columns, but in a clockwise direction, with the correct answer 912 highlighted in green in the horizontal answer selection bar 910.

### C. Boolean Logic.

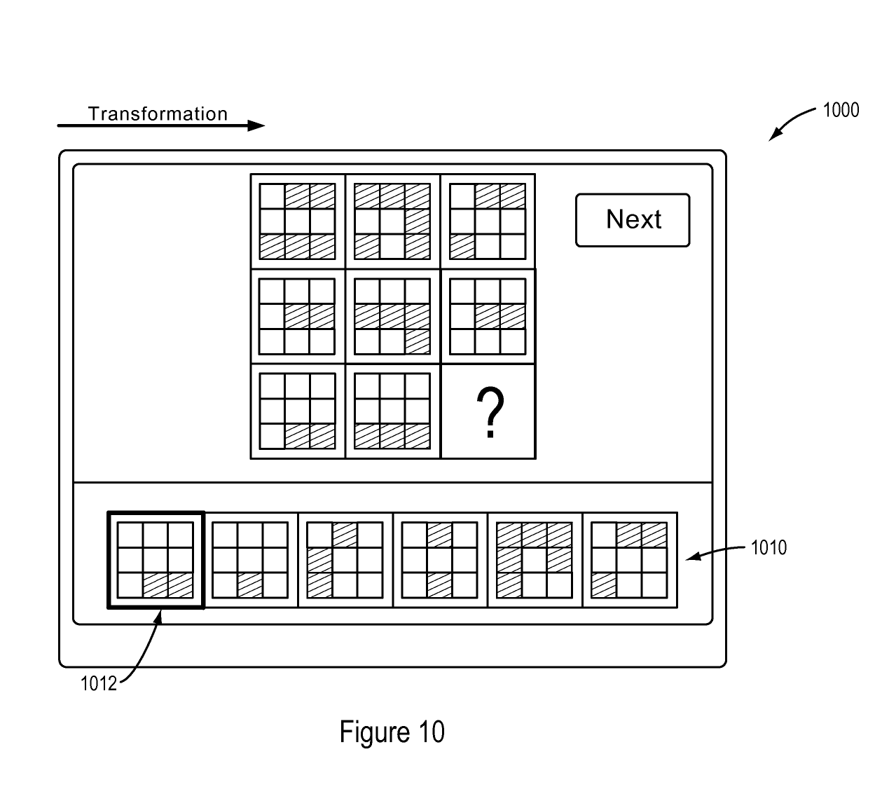

The graphic is either the aforementioned 3×3 grid 1000 or the seven segments commonly used to display LCD digits (FIG. 10) and an answer bar 1010. Again, transformations may work on the horizontal or the vertical axis, so each problem presents three trios. In each trio, the first two shapes are randomly determined. Then, one of the Boolean operators AND, OR, and XOR is applied to the pair's segments to determine what segments appear in the third shape. For example, see FIG. 10, in which the transformation occurs across the rows using the AND rule. A square is darkened in the right column if and only if that location is darkened in both of the two graphics to its left. The correct answer is highlighted 1012.

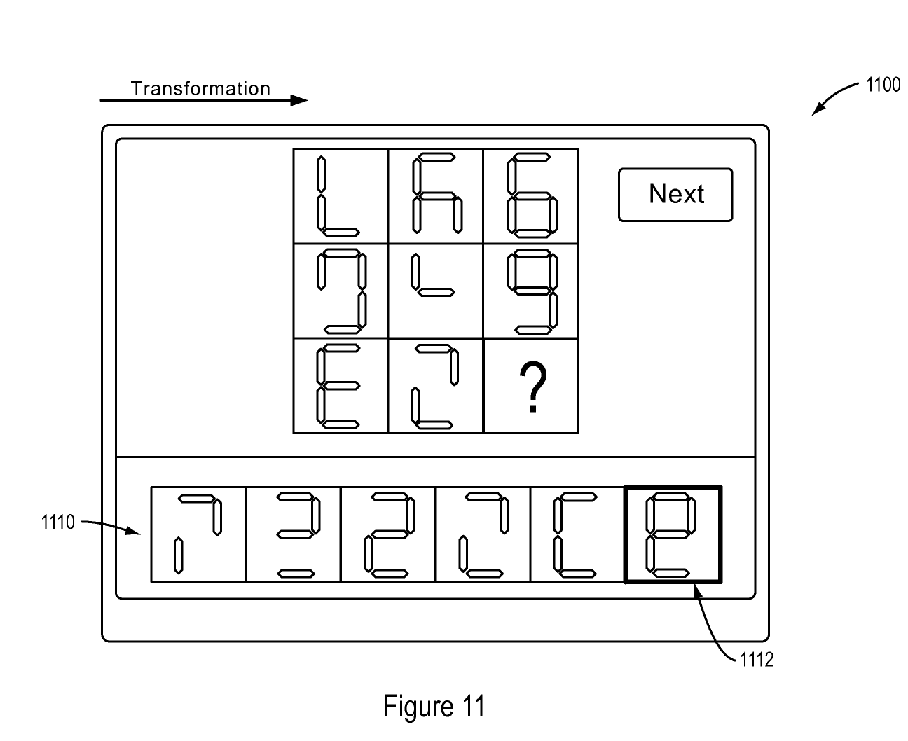

For an example using the LCD digital display, see FIG. 11. Here, the OR rule is used across the rows of the grid 1100. A segment appears in the rightmost column if and only if it appears in at least one of the two illustrations to its left. Similarly, an XOR calculation would display a segment if and only if it was visible in exactly one of its two mates.

The correct answer 1112 is randomly placed in one of the six possible response slots located in the response bar 1110. In addition, five distracter items are included as well. The distracter items are selected using any of the following methods:
A shape from elsewhere in the problem is chosen.
A shape from elsewhere in the problem is chosen, and one aspect of it is changed.
One aspect of the correct answer is changed.
One aspect of a previously generated distracter is changed.
A shape is pieced together from random aspects represented in the problem.
A new shape is randomly generated.

Trials progress from easy to hard by changing the trial group type. In one embodiment, types of trials are grouped into 17 categories (TABLE 1).

TABLE 1

| | | | No. |
|---|---|---|---|
| | Change | | changing |
| Group | dimensions | Change direction | dimensions |
| 1 | color, count | horizontal, vertical | 1 |
| 2 | rotation, shape, | horizontal, vertical | 1 |
| | size | | |
| 3 | color, count | diagonals, outward | 1 |
| 4 | rotation, shape, | diagonals, outward | 1 |
| | size | | |
| 5 | color +* | horizontal + vertical, | 2 |
| | | horizontal + diagonals, | |
| | | vertical + diagonals | |
| 6 | color +* | horizontal + vertical, | 2 |
| | | horizontal + diagonals, | |
| | | vertical + diagonals | |
| 7 | all combinations | outward +*, Diagonal | 2 |
| | of 2 not including | (Lower left to upper | |
| | color | right) + Diagonal(Upper left | |
| | | to lower right) | |
| 8 | all combinations | outward +*, Diagonal | 2 |
| | of 2 not including | (Lower left to upper | |
| | color | right) + Diagonal(Upper left | |
| | | to lower right) | |
| 9 | color +* +* | horizontal + vertical + | 3 |
| | | outward, all other | |
| | | combinations not | |
| | | including outward | |
| 10 | color +* +* | horizontal + vertical + | 3 |
| | | outward, all other | |
| | | combinations not | |
| | | including outward | |
| 11 | all combinations | all combinations including | 3 |
| | of 3 not including | outward except | |
| | color | horizontal + vertical + | |
| | | outward | |
| 12 | all combinations | all combinations including | 3 |
| | of 3 not including | outward except | |
| | color | horizontal + vertical + | |
| | | outward | |
| 13 | Grid position | horizontal/vertical | Movement |
| 14 | Grid position | Rotation around center | Movement |
| 15 | Orbital placement | Rotation around center | Movement |
| 16 | OR | Vertical, Horizontal | Boolean |
| | | | Logic |
| 17 | AND/XOR | Vertical, Horizontal | Boolean |
| | | | Logic |

*is a wildcard which is a parameter chosen from an available parameter.

Each trial type group represents a difficulty level defined by rule type (Progression Matrices, Orbital/Lateral Movement, or Boolean Logic) change dimension (count, color, shape, rotation, or size for Progression Matrices; grid position or orbital placement for Orbital/Lateral Movement; OR, AND, or XOR for Boolean Logic), change direction (horizontal, vertical, diagonal (upper left to lower right or lower left to upper right), or outward), and number of changes (1-3) per matrix. The test session is defined by a set number of trials—17 (one from each group) in this instance. Examples of each of the three trial types listed above are used (in the order listed in Table 1). Other numbers of trials could be used, as well. In addition, a timer can be added such that the user needs to complete as many trials in a set amount of time as possible. There is a tradeoff between compliance and reliability of the measurement, with shorter tests being completed more frequently with less reliability than longer tests.

The raw score is defined by the number of correct trials in the session. Index scores are created by normalizing the performance relative to others of similar demographics. For example, percentile normalization is used to transform relative performance within a particular age group into a score based on a normally distributed score with a mean of 100 and a standard deviation of +/−15, as is common in IQ testing. The index scores can also be used as a component of a battery of assessments to provide a more comprehensive picture of an individual's cognitive abilities.

In another implementation, the system can be configured to determine the level of difficulty where the user reaches their threshold. For example, an up-down method could be used whereby difficulty would start at an easy level and be made more difficult each time a correct answer was made and less difficult each time an incorrect answer was made. Such a method is referred to as a one-up/one-down staircase method and averaging the last several inflection points (where a user goes from getting correct answers to getting an incorrect answer and vice versa) yields a threshold level of performance corresponding to 50% correct. Other thresholds could be used, as well, by using different numbers of correct or incorrect answers to change direction in the staircase. For example, a two-up/one-down method requires the user to get two correct answers before making the task more difficult and one incorrect answer before making it easier again. This approach converges to 70.7% correct. In this method, the average of the last several (say 4 of 6) reversals, would be taken as the raw score to be indexed. This method takes advantage of the fact that this method allows for the definition of difficulty level for a particular trial type.

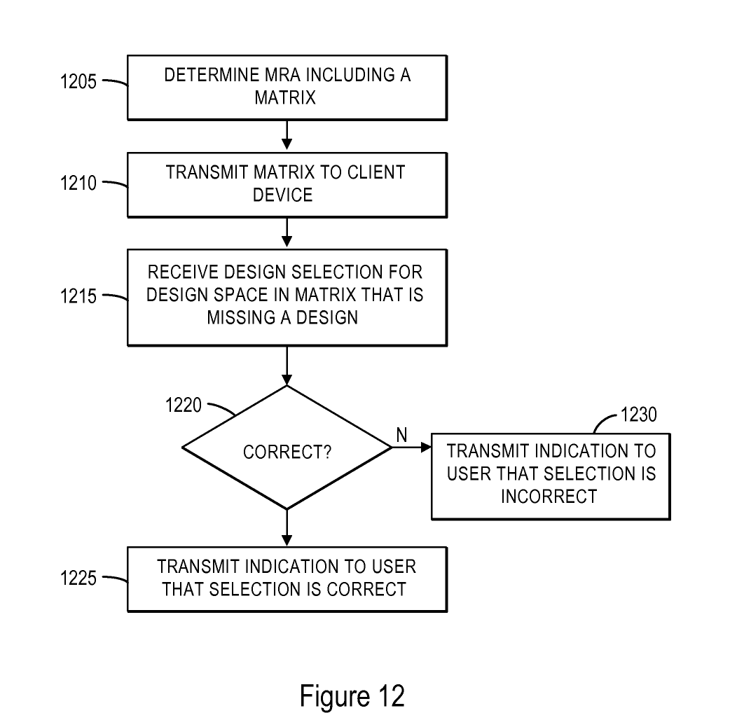

FIG. 12 is an example of a flowchart performed by a computing device such as server 110. The server 110 may include one or more software or hardware modules or computing logic to perform the illustrated steps. The computing device determines an MRA (Step 1205) to assess fluid intelligence of a user operating a client computer/device. As described above, the MRA includes a matrix having designs in design spaces, where the designs in the matrix together form one or more patterns. The matrix has one or more design spaces in the matrix that are missing a design. Examples of a design include, without limitation, a number, a letter, a symbol. a shape, a picture, an image, a photograph, an icon, an animation, a video, audio, or any other symbol, character, or representation that can be used in a pattern. In one embodiment, the computing device transmits the matrix to the client device (Step 1210). The user responds with a design for the “empty” design space (i.e., the design space previously missing a design) and the computing device receives this design selection (Step 1215).

The computing device determines whether the received design is correct for the design space (Step 1220). The computing device then transmits to the user an indication as to whether the received design is correct for the design space. (Step 1225 or Step 1230). This indication may be shading of the correct design or displaying the correct design in a specific or different color.

In one embodiment, a user selects the design from an options section displayed near (e.g., below) the displayed matrix. The computing device may determine the size of the matrix and/or the shape of the matrix before transmitting the matrix to the client device for display.

As described above, the matrix in the MRA may be determined from one or more of a variety of rules, such as progression matrix rules, orbital or lateral movement rules, and/or boolean logic rules. In one embodiment, the computing device adjusts the difficulty of the matrix/pattern, and this adjustment may be based on if the user selected a correct design for the missing design space, the number of correct designs selected by the user for different matrices, the difficulty level of the current matrix, etc.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method comprising:
determining, by a computing device, a matrix reasoning assessment to assess fluid intelligence of a user operating a client device, the matrix reasoning assessment comprising a matrix having designs in design spaces, the designs forming a pattern, and the matrix also having at least one design space in the matrix missing a design;
transmitting, by the computing device to the client device, the matrix;
receiving, by the computing device and from the user via the client device, a design for the at least one design space missing the design;
determining, by the computing device, whether the received design from the user is correct for the at least one design space; and
transmitting, by the computing device to the client device, an indication as to whether the received design is correct for the at least one design space.

2. The method of claim 1, further comprising transmitting, by the computing device to the client device, an options section providing potential designs for the at least one design space missing a design.

3. The method of claim 2, further comprising receiving, by the computing device from the user via the client device, a selection of at least one of the potential designs for the at least one design space missing a design.

4. The method of claim 1, wherein the transmitting of the indication further comprises transmitting the design in a different color or shaded in a specific color.

5. The method of claim 1, further comprising determining, by the computing device, a size of the matrix.

6. The method of claim 1, further comprising determining, by the computing device, a shape of the matrix.

7. The method of claim 1, wherein the determining of the matrix reasoning assessment further comprises determining the matrix via progression matrix rules.

8. The method of claim 1, wherein the determining of the matrix reasoning assessment further comprises determining the matrix via orbital or lateral movement rules.

9. The method of claim 1, wherein the determining of the matrix reasoning assessment further comprises determining the matrix via boolean logic rules.

10. The method of claim 1, further comprising adjusting difficulty of the matrix in the matrix reasoning assessment.

11. The method of claim 1, further comprising repeating the transmitting, receiving and determining steps a plurality of times during a session.

12. The method of claim 11 further comprising the step of determining a raw score of a number of correct received designs from the user in a session.

13. The method of claim 11 further comprising the step of normalizing a performance of a first user to a performance of a second user.

13. A computing device comprising:
a processor;
a storage medium for tangibly storing thereon program logic for execution by the processor, the program logic comprising:
matrix reasoning assessment determining logic executed by the processor for determining a matrix reasoning assessment to assess fluid intelligence of a user operating a client device, the matrix reasoning assessment comprising a matrix having designs in design spaces, the designs forming a pattern, and the matrix also having at least one design space in the matrix missing a design;
matrix transmitting logic executed by the processor for transmitting, to the client device, the matrix;
design receiving logic executed by the processor for receiving, from the user via the client device, a design for the at least one design space missing the design;
design determining logic executed by the processor for determining whether the received design from the user is correct for the at least one design space; and
indication transmitting logic executed by the processor for transmitting, to the client device, an indication as to whether the received design is correct for the at least one design space.

14. The computing device of claim 13, further comprising options section transmitting logic executed by the processor for transmitting, to the client device, an options section providing potential designs for the at least one design space missing a design.

15. The computing device of claim 14, further comprising selection receiving logic executed by the processor for receiving, from the user via the client device, a selection of at least one of the potential designs for the at least one design space missing a design.

16. The computing device of claim 13, wherein the indication transmitting logic further comprises design transmitting logic executed by the processor for transmitting the design in a different color or shaded in a specific color.

17. The computing device of claim 13, further comprising size determining logic executed by the processor for determining a size of the matrix.

18. The computing device of claim 13, further comprising shape determining logic executed by the processor for determining a shape of the matrix.

19. The computing device of claim 13, wherein the matrix reasoning assessment determining logic further comprises determining logic for determining the matrix via progression matrix rules.

20. The computing device of claim 13, wherein the matrix reasoning assessment determining logic further comprises determining logic for determining the matrix via orbital or lateral movement rules.

21. The computing device of claim 13, wherein the matrix reasoning assessment determining logic further comprises determining logic for determining the matrix via boolean logic rules.

22. The computing device of claim 13, further comprising difficulty adjusting logic executed by the processor for adjusting difficulty of the matrix in the matrix reasoning assessment.

23. A non-transitory computer readable storage medium tangibly storing computer program instructions capable of being executed by a computer processor, the computer program instructions defining a method comprising:
determining, by the processor, a matrix reasoning assessment to assess fluid intelligence of a user operating a client device, the matrix reasoning assessment comprising a matrix having designs in design spaces, the designs forming a pattern, and the matrix also having at least one design space in the matrix missing a design;
transmitting, by the processor to the client device, the matrix;
receiving, by the processor and from the user via the client device, a design for the at least one design space missing the design;
determining, by the processor, whether the received design from the user is correct for the at least one design space; and
transmitting, by the processor to the client device, an indication as to whether the received design is correct for the at least one design space.
